(19) United States
(12) Patent Application Publication
(10) Pub. No.: US 2025/0245984 A1
(43) Pub. Date: Jul. 31, 2025

(54) METHODS AND SYSTEMS FOR ESTIMATING CROP YIELD FROM VEGETATION INDEX DATA

(71) Applicant: DIGIFARM AS, Hamar (NO)

(72) Inventors: Alexei MELNITCHOUCK, Calgary (CA); Konstantin VARIK, Javea Alicante (ES); Nils HELSET, Ridabu (NO); Yosef AKHTMAN, St-Prex (CH)

(21) Appl. No.: 18/854,290

(22) PCT Filed: Apr. 4, 2023
(86) PCT No.: PCT/NO2023/050079

§ 371 Date: Oct. 4, 2024

(30) Foreign Application Priority Data
Apr. 5, 2022 (NO) 20220416

(51) Int. Cl. G06V 20/10; A01C 21/00; A01D 41/127; G06T 3/4053; G06V 10/764; G06V 10/766; G06V 10/82; G06V 20/13; G06V 20/17

(52) U.S. Cl. CPC G06V 20/188; A01D 41/127; G06T 3/4053; G06V 10/764; G06V 10/766; G06V 10/82; G06V 20/13; A01C 21/007; G06V 20/17

(57) ABSTRACT

Method and corresponding system for estimating crop yield from vegetation index data. At least one multispectral image (201) including a field is obtained. The part of the multispectral image (201) that represents the agricultural field (301) is delineated, and vegetation indices for locations within the agricultural field (301) are derived from the multispectral image (201). Samples of actual yield data representing yield measurements for locations within the agricultural field (301) are obtained as measured by a yield monitor on a combine harvester (208) used to harvest selected areas of the agricultural field (301). By correlating the vegetation indices with the yield data, a relationship between respective vegetation index values and corresponding absolute yield estimates is determined. The determined relationship can be used to obtain estimates of actual yield from different parts of the field, and this information can be used to identify field maintenance needs, fertilization rates, and more.

The present invention relates to methods and systems for estimating crop yield from vegetation index data, and in particular to scalable and automated methods and systems that do not depend on manual field work.

### BACKGROUND

Precision farming, also known as precision agriculture, refers to farming management consisting of a wide range of technological solutions developed in order to improve decision making in a manner that optimizes results while conserving resources. These solutions aim to achieve significant improvements in efficiency and productivity by in-field optimization of agrochemical operations involved in the cultivation of agricultural produce. In particular these methods may rely on digital imaging data obtained from Earth Observation satellites as well as other sources of information in order to analyze the condition of the growing plants and assist the farmer to make optimum operational decisions throughout the growing season. Most of such methods rely on precise knowledge of georeferenced boundaries of individual fields in order to enable accurate analysis of the satellite imagery and other georeferenced precision farming data, such as soil information, yield monitor data, etc.

One particularly important data layer in precision agriculture relates to yield information and the ability to estimate actual or potential yield in some or all parts of the field. Fertilizer is applied to fields in order to replace nutrients that have been removed from the soil by growth and harvesting, and this removal rate is a function of yield. Consequently, the ability to determine site-specific yield with a certain accuracy will provide a farmer with important parameters for planning of appropriate fertilizer rates. After harvesting is complete it will, of course, be known what the total yield for a given field is. However, yield mapping is also used as a tool to identify problematic areas within the field, as well as the best yielding zones, which is very important for making right agronomic decisions. Also, when the field is ready to be harvested it may be useful to be able to estimate total yield early rather than having to wait until the entire field has been harvested. Such early estimates may, for example, be useful in when planning the logistics of transportation, the ability to deliver certain amounts, etc.

In the last decades, collection of site-specific yield data has been done using yield monitors. Sensors installed on combine harvesters record information about the grain flow at specific locations in the field (e.g., as determined by GPS), and converts this information to absolute yield units, such as tons per hectare or bushels per acre. This conversion depends on proper calibration, and this is one of the main challenges of yield data collection in the field. If several combine harvesters are used and the calibration of their respective yield monitor sensors differ, the resulting yield data will be inaccurate, maybe even meaningless.

There is therefore a need for new and scalable methods and systems that are capable of providing accurate site-specific yield data that may facilitate yield mapping, setting of yield goals for future growing seasons, and improved planning of fertilization rates specific to individual fields.

### SUMMARY OF THE DISCLOSURE

The needs outlined above are addressed by the present invention which in a first aspect provides a method in a computer system for estimating crop yield for an agricultural field from vegetation index data. The method comprises obtaining at least one multispectral image of an area in which the field is located; delineating the part of the multispectral image that represents the agricultural field; deriving vegetation indices for locations within the agricultural field from the delineated part of the multispectral image; obtaining samples of actual yield data representing yield measurements for locations within the agricultural field as measured by a yield monitor on a combine harvester used to harvest selected areas of the agricultural field; and correlating the vegetation indices with the yield data to determine a relationship between respective vegetation index values and corresponding absolute yield estimates.

In some embodiments delineation of the part of the multispectral image may be performed by automatically obtaining field delineation data from a repository of such information. However, such delineation date may not be available, or may be inaccurate or outdated. Some embodiments may therefore be configured to perform delineation of the part of the multispectral image performed by obtaining at least one multitemporal, multispectral satellite image sequence from an earth observation satellite system; improving the resolution of the multitemporal, multispectral satellite image sequence with a super-resolution method to generate a high-resolution image sequence where corresponding pixel positions in images in the sequence relate to the same geographical ground position; and using a delineating artificial neural network to classify pixel positions in the high-resolution image sequence as being associated with a geographical ground position that is or is not part of the agricultural field.

In some embodiments of the invention the multispectral image of the area in which the field is located is obtained using at least one of an earth observation satellite system, an airplane, and a drone.

While the multispectral image provides the data necessary for obtaining vegetation indices, these indices are correlated with actual yield data. In some embodiments samples of actual yield data are obtained by selecting areas that, according to the multispectral image, represent a range of vegetation index values including extremes, harvesting the selected areas with the combine harvester, and using grain flow rate data and corresponding position information from the yield monitor to determine the yield measurements for locations within the agricultural field. This gives a selection of absolute yield data for locations in the field for which vegetation indices are also available. The relationship between vegetation indices and absolute yield may then be found, for example by using regression analysis. This relationship may be expressed as an equation that takes vegetation index as input and produces an absolute yield estimate as output.

Obtaining the multispectral image of the field is obtained at or near the peak of the growing season can be expected to give the best estimate of absolute yield from vegetation indices. However, the invention may be adapted for other purposes. For example, in some embodiments at least one first multispectral image of the area in which the field is located has been obtained early in a previous growing season, the samples of actual yield data were obtained during harvesting in the same previous growing season, regression analysis was used to determine a prediction equation that converts early season vegetation index to predicted absolute yield estimate. With this prediction equation available at least one second multispectral image of the area in which the field is located can be obtained early in the current growing season, and the determined prediction equation may be used to determine a predicted absolute yield for the current growing season from the at least one second multispectral image of the area in which the field is located.

The absolute yield estimate is delivered as input to a process of determining at least one of a future fertilization rate, a future irrigation rate, and a future use of pesticides.

In another aspect of the invention a system for estimating crop yield for an agricultural field from vegetation index data is provided. Such a system includes a field delineation module configured to receive at least one multispectral image of an area in which the field is located and delineate the part of the multispectral image that represents the agricultural field; a field indexing module configured to receive the delineated part of the at least one multispectral image and derive vegetation indices for locations within the agricultural field; a yield estimation module configured to receive samples of actual yield data representing yield measurements for locations within the agricultural field as measured by a yield monitor on a combine harvester used to harvest selected areas of the agricultural field, and to correlate the vegetation indices with the yield data to determine a relationship between respective vegetation index values and corresponding absolute yield estimates.

In some embodiments of the system the field delineation module is further configured to obtain at least one multitemporal, multispectral satellite image sequence from an earth observation satellite system; improve the resolution of the multitemporal, multispectral satellite image sequence with a super-resolution method to generate a high-resolution image sequence where corresponding pixel positions in images in the sequence relate to the same geographical ground position; and use a delineating artificial neural network to classify pixel positions in the high-resolution image sequence as being associated with a geographical ground position that is or is not part of the agricultural field.

A system according to the invention may further comprise such modules as, for example, a multispectral camera module configured to be carried by an airplane or a drone and to communicate with the field indexing module, or a yield monitor module with a positioning capability and configured to be mounted on a combine harvester and to communicate with the yield estimation module.

In some embodiments a system according to the invention may further comprise an output module configured to receive as input the determined relationship found by the yield estimation module together with vegetation index values for the field and to produce as output at least one of: a table of absolute yield estimates, an estimated total yield for the field, and a yield map.

In yet another aspect of the invention a computer program product is provided as instructions carried on a computer readable medium. The instructions enable a computer system to perform the steps of the method described above.

### BRIEF DESCRIPTION OF THE DRAWINGS

A detailed description of embodiments will now be given with reference to the drawings where

FIG. 1 is a flow chart illustration of steps in an embodiment of the invention;

FIG. 2 shows an example of a system operating in accordance with the invention;

FIG. 3 shows an example of a satellite image with a detected field border;

FIG. 4 is an example of a vegetation index map;

FIG. 5 is a yield map of the same area, where a part of the field has been harvested; and

FIG. 6 is a virtual yield map as it may be provided by an embodiment of the invention.

### DETAILED DESCRIPTION

The present invention will be better understood with reference to the following detailed description of exemplary embodiments with reference to the attached drawings. However, those skilled in the art will readily appreciate that the detailed descriptions given herein are intended for explanatory purposes and that the methods and systems may extend beyond the described embodiments.

The drawings are not necessarily to scale. Instead, certain features may be shown exaggerated in scale or in a somewhat simplified or schematic manner, wherein certain conventional elements may have been left out in the interest of exemplifying the principles of the invention rather than cluttering the drawings with details that do not contribute to the understanding of these principles.

It should also be noted that, unless otherwise stated, different features or elements may be combined with each other whether or not they have been described together as part of the same embodiment below. The combination of features or elements in the exemplary embodiments are done in order to facilitate understanding of the invention rather than limit its scope to a limited set of embodiments, and to the extent that alternative elements with substantially the same functionality are shown in respective embodiments, they are intended to be interchangeable, but for the sake of brevity, no attempt has been made to disclose a complete description of all possible permutations of features.

Furthermore, those with skill in the art will understand that the invention may be practiced without many of the details included in this detailed description. Conversely, some well-known structures or functions may not be shown or described in detail, in order to avoid unnecessarily obscuring the relevant description of the various implementations. The terminology used in the description presented below is intended to be interpreted in its broadest reasonable manner, even though it is being used in conjunction with a detailed description of certain specific implementations of the invention.

References to “one embodiment,” “at least one embodiment,” “an embodiment,” “one example,” “an example”, “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Yield in field crops is an integrated result of many different factors, including plant available nutrients in the soil (N, P, K, S, Ca, Mg, micronutrients), soil properties (texture, moisture, organic matter content, pH, soil compaction), weather (temperature and growing degree days, precipitations, wind speed and direction, solar radiation, etc.), field topography (elevation, field surface curvature, slope, aspect), varieties or hybrids of field crops and their interaction with the environment, field machinery, application of crop inputs (fertilizers, crop protection products, etc.), and many other factors. This combination of natural, agronomic, and technological factors is unique in every field, so it is almost impossible to plan or forecast yield potential based just on soil properties or genetic potential of hybrids or varieties.

However, site-specific yield information is one of the most important data layers in precision agriculture. In most cases, fertilizer rates are planned based on nutrient removal rates. These removal rates are defined as the amounts of nitrogen, phosphorus, potassium, and the other nutrients that field crops uptake from soil to produce yield, and measured in kilograms per ton, pounds per bushel, etc. Therefore, together with the results of soil analysis, site-specific yield mapping is required for planning of accurate fertilizer rates.

In addition, yield mapping has many other important applications in farming, such as documentation of yield, conduction of field experiments, negotiation of crop lease and price, planning of on-farm logistics, etc.

In the last decades, collection of site-specific yield data has been done with yield monitors. Using a sensor installed on a combine harvester, the yield monitor records information about the intensity of grain flow and associates this grain flow with a position in the field as determined, for example, by satellite positioning (GPS). This information is then converted to absolute yield units, such as tons per hectare or bushels per acre. To perform this conversion, the yield monitor must be properly calibrated, and this is one of the main challenges of yield data collection in the field. If the field is harvested by more than one combine harvester, each combine harvester must be calibrated accurately to obtain a consistent yield map. If calibration of the respective yield monitors on several combines harvesting the same field differ, this will lead to meaningless, or at least inaccurate, yield data. There are also additional challenges associated with yield mapping based on yield monitors mounted on combine harvesters. For example, if the combine harvester for some reason does not harvest grain across its full swath the yield data will be too low for that part of the field. Identifying and correcting for such errors may be difficult or impossible.

The present invention provides features that help facilitate and streamline creation of site-specific yield maps. This is achieved based on a combination of several data layers, such as field boundaries, remote sensing data (airborne or satellite imagery), and ground calibration data. The collection of data from these data layers as well as the processing of the data in order to obtain the desired results and generate the required output is based on automation and achieves scalability in a manner that is not available with existing methods.

The most common application of remote sensing in agriculture is to analyze crop conditions using a combination of near-infrared (NIR) and red parts of the spectrum. Healthy vegetation absorbs more than 80% of the red light, and it also reflects more than 80% of the near-infrared radiation. By comparing the amount of NIR radiation reflected from crop canopy with the amount of red light absorbed by plants, crop conditions can be readily estimated in the field. In remote sensing there is a large number of vegetation indices developed for this particular purpose; the most known indices are Normalized Difference Vegetation Index (NDVI) and Enhanced Vegetation Index (EVI). These are well known to people skilled in the art, and they will not be explained in detail herein.

Spectral indices are excellent indicators of field variability. By analyzing satellite, aerial or drone imagery, areas with higher and lower green biomass can be identified. Moreover, at the peak of the growing season, vegetation indices are strongly correlated with grain yield. However, there are no vegetation indices that would be able to quantify green biomass or predict grain yield in bu/acre or t/ha without additional information. To convert vegetation index to grain yield, additional ground truthing data are required. Yield forecast on a large scale, e.g., country, is done by the governmental organizations (e.g. USDA, Statistics Canada, etc.) and private companies. To achieve this, historical yield data at the country scale is cross-referenced with current remote sensing information. However, for field- or site-specific yield prediction, detailed information on crops and varieties, moisture conditions, soil fertility, and other factors, is required. Without such data, field- or site-specific yield forecast can be more than 30-40% off its actual value.

It is difficult to take all the factors that influence yield into account. In many cases, this information is simply unavailable. The easiest way to convert NDVI or EVI into grain yield is to follow a standard agronomic procedure. First the number of heads per unit area (square meter or square foot) are calculated for certain areas in the field. Then the average number of grains in each head is also found. Then the 1,000-kernel weight is found and used to calculate the estimated yield for the respective field areas by multiplying area with number of heads per unit area, average number of grains per head and 1,000-kernel weight (with necessary conversions for units used). The result is an estimated grain yield in absolute units, such as tons per hectare or bushels per acre. Such ground truthing results from different parts of the field can now be correlated with vegetation indices, such as NDVI, EVI, or any others and, therefore, transform the dimensionless scale of vegetation indices into the absolute yield units. The disadvantage with this procedure is that it requires a lot of manual work. The method is well known in the industry and a description can be found at https://www.oldscollege.ca/olds-college-smart-farm/articles/yield-forecast-virtual-yield-mapping-and-yield-loss-assessment/index.html, which is hereby incorporated by reference.

The present invention provides further automation of the process of yield estimation, which in turn will facilitate improved planning of fertilization rates and other decision making involved in precision farming.

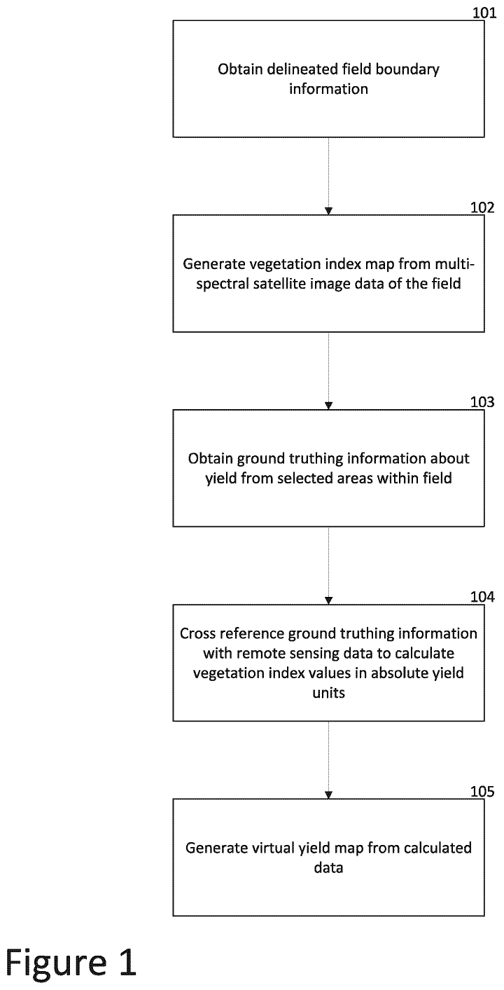

Reference is first made to FIG. 1 which is a flow chart illustration of the main steps in a method consistent with the principles of the invention. It should be understood that the overview presented with reference to this drawing may include details that are not necessarily part of all embodiments of the invention, and, conversely, that some details may be left out from the description of this overview while they may be described with reference to other drawings. This should not be interpreted as representing different embodiments. Rather, the overview represented by FIG. 1 is intended to provide an understanding of the overall flow of information and performance of steps. Some of these steps may be common to most embodiments, while some may be optional, or they may have been performed prior to or will be performed subsequent to the steps performed by a specific embodiment of the invention. For example, some embodiments may include steps to obtain satellite images from which field delineation is performed while other embodiments are simply able to access field delineation data from a repository of such information. Details and various embodiments will be discussed when the respective steps of FIG. 1 are explained in further detail with reference to the additional drawings.

It should be noted that steps are referred to first, second, and so on in order to identify them from each other, not in order to prescribe a specific sequence. Whether a particular step must be performed before or subsequent to another step depends on whether one of the steps relies on, i.e., takes as input, the results, i.e., the output, of another step. And even when this is the case it does not necessarily follow that the prior step needs to be completed before the subsequent step can commence. Instead, in some cases or embodiments a step may provide a partial result before it concludes, and the subsequent step may be initiated with the partial results before the prior step is completed.

In a first step 101 of the method illustrated in FIG. 1 field boundary delineation is performed. The purpose of this step is to provide accurate, georeferenced field delineation information. Simply speaking, this step obtains information that specifies the exact location and shape of a particular field. What “exact” means in terms of accuracy may, of course, vary according to needs. The point is to obtain information that is sufficiently accurate to support the subsequent steps of the method and enable a final result that supports decision making that makes it possible to obtain the improvements that are the goal of precision farming.

Several methods of field delineation are known in the art, and the invention does not depend on any specific one of them. One suitable method is described in Norwegian patent application 20211116 and corresponding applications in other countries. This method involves obtaining at least one multitemporal, multispectral satellite image sequence from earth observation satellites. The obtained images are pre-processed to generate a pre-processed image sequence of multitemporal multispectral images covering a specific geographical region. A super-resolution method may be used on the images in the pre-processed image sequence to generate a high-resolution image sequence where corresponding pixel positions in images in the sequence relate to the same geographical ground position. A delineating artificial neural network is then used to classify pixel positions in the high-resolution image sequence as being associated with a geographical ground position that is or is not part of an agricultural field.

The content of the above-mentioned patent application is hereby incorporated by reference, but as already mentioned the present invention may utilize other methods for field delineation.

In a following step 102 a vegetation index map is generated from multispectral image data of the field, or such information is obtained from a repository of already available vegetation index information. The multispectral satellite images of the field should be obtained at or near the peak of the growing season such that the images contain as much information about the vegetation as possible. It will be readily understood that outside the growing season there will be no relevant information about crop vegetation in satellite images, and early in the growing season relevant information may be too sparse and not sufficiently indicative of actual yield by the time the crop may be harvested.

The field delineation information from the first step 101 is used to generate a vegetation index map for the area inside the boundary of the field. The vegetation index may be Normalized Difference Vegetation Index (NDVI, Enhanced Vegetation Index (EVI), or any other spectral indices obtained from remote sensing data which show variability of green biomass and, therefore, yield potential across the field.

In step 103 ground truthing information about yield is obtained. As mentioned above, this information has traditionally been obtained by skilled agronomists in the field. However, this is time consuming and not scalable. Another source of yield related information is to use yield monitors which often are mounted on combine harvesters. A yield monitor measures the harvested grain mass flow during operation and may also measure moisture content and speed in order to establish an estimate of total grain harvested. Yield monitors on combine harvesters only measure production that is actually harvested and cannot provide any estimate of yield prior to harvesting.

The present invention is based on the realization that use of a combine harvester with a calibrated yield monitor to harvest selected areas of a field, preferably including areas that according to the vegetation index span from minimum to maximum yield, it is possible to correlate yield at a specific position, as measured by the yield monitor, with the vegetation index in order to convert the relative yield estimates provided by the index to an absolute yield estimate.

The resulting absolute yield index can be used in a final step 105 to generate a virtual yield map with yield predictions for an entire field based on harvesting of only select areas. The results can also be used to generate an estimate of the total yield for the entire field. The steps shown in FIG. 1 will now be described in further detail. As described above the invention relies on use of multispectral images obtained from satellites, drones, airplanes, or in a similar manner. For input as well as output reasons this information must be confined to separate fields. First, in order to be able to correlate vegetation index information with absolute yield it is necessary to process input that essentially relates to only one type of vegetation. For example, for reasons that will be apparent to a skilled person, if vegetation index information includes an area with trees as well as grain, the vegetation index for the area with trees will produce a positive prediction for grain yield from the trees, which is clearly incorrect. For similar reasons, if two adjacent fields carry two different crops, for example wheat and corn (maize), the yield from the two crops cannot be expected to correlate similarly with vegetation index. Consequently, in order to obtain accurate results, input should be per field with a given type of crop.

Similarly, the output desired will be per field. A farmer will be interested in knowing how a given crop in a given field can be expected to yield, and how actual yield varies across the field. Also, for this reason it is desirable to have accurate delineation for individual fields.

Delineation information may be available from a number of sources, with varying degrees of accuracy. In some embodiments of the invention delineation information (i.e., field borders) are fetched from a database of preexisting information. However, in many cases such information may have insufficient accuracy or be outdated. Furthermore, even if field borders remain the same in terms of ownership, the extent to which the use of a field is exactly the same from one growing season to the next may vary. Some years parts of a field may be unused, or a field may be subdivided into areas used for different crops. Some embodiments therefore obtain satellite or aerial images of the field and perform automatic field delineation based on image processing, for example as described in NO 20211116 referenced above.

Automatic delineation may take multitemporal, multispectral satellite image sequences as input and determine field boundaries based on how multispectral radiation changes over time during the growing season. This means that the field borders detected represent the actual extent of the crop that is subject to yield estimation in accordance with the present invention.

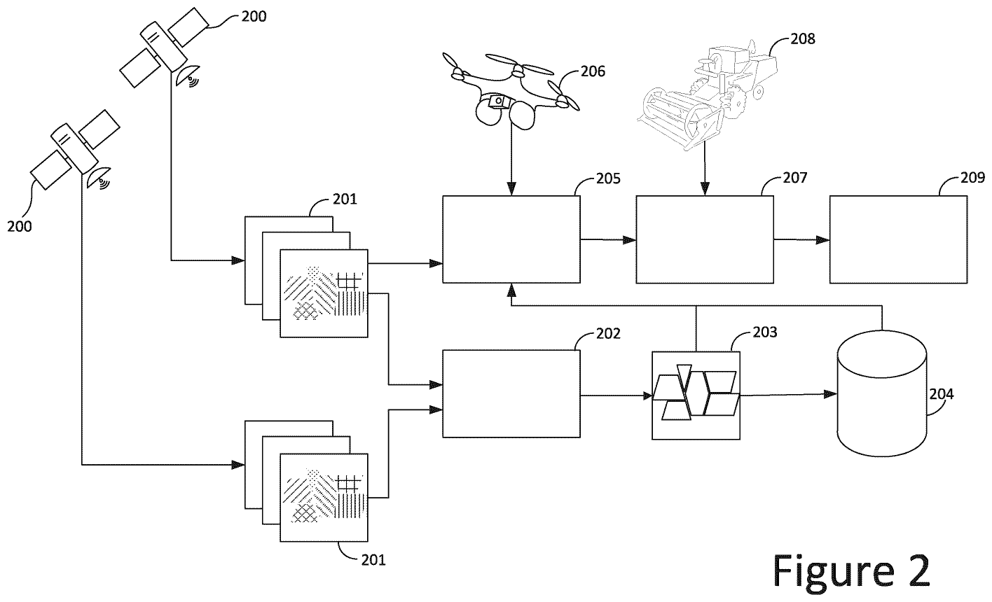

FIG. 2 shows an example of a system operating in accordance with the invention. The drawing includes optional modules and modules external to the system, as will be readily understood by those with skill in the art. Two earth observation satellites 200 provide respective sequences of multitemporal, multispectral satellite images 201. These images are delivered as input to a system 202 which is configured to process these images and determine field boundaries which are delivered as output images or image masks 203 that are georeferenced. In some embodiments the results of the delineation module 202 may be stored in a database 204 which is available online, for example on the Internet. The process performed by the delineation module 202 substantially corresponds to step 101 in FIG. 1.

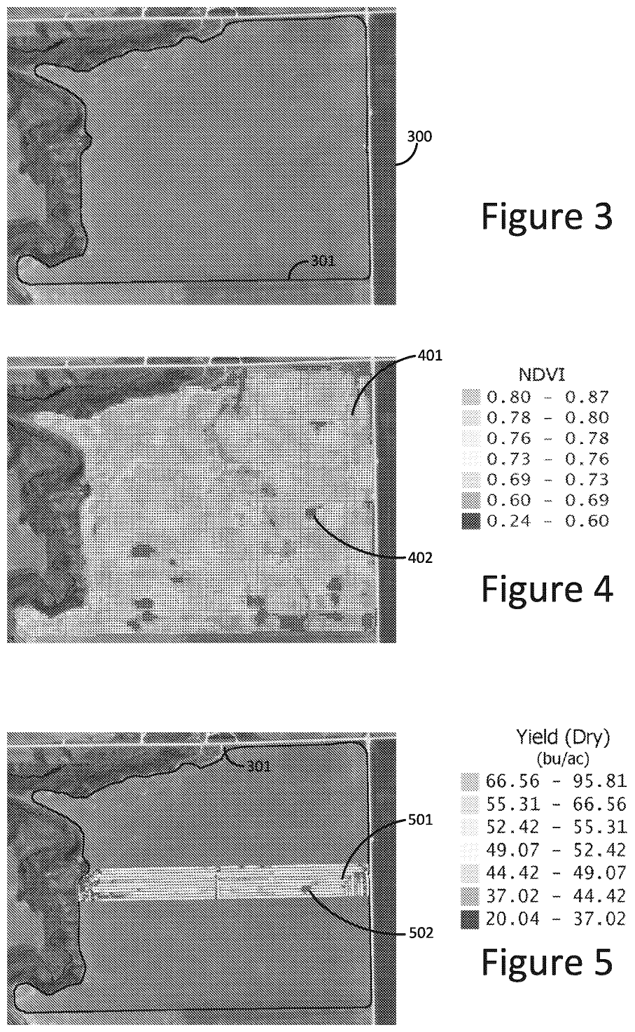

FIG. 3 shows an example of a satellite image 300 with a detected field border 301.

Returning to FIG. 2, the system according to the invention may now obtain delineation information either directly from the delineation module 202, which may be an integral part of the system itself, or from a repository 204 from which such information is available. The system may also obtain satellite or aerial images of the area in which the field is located. If the system uses satellite images for this part of the process the image or images may originate from one of the satellites 200 or satellite systems used to provide images 201 for the delineation module 202 and may even be selected from among these images. However, the image or images used at this step of the process should be multispectral, but they should not be multitemporal. Instead, for an accurate estimate of actual yield they should be acquired at or near the peak of the growing season. Instead of satellite images, aerial images may be used, for example images obtained from a drone 206. The images should be georeferenced such that they may be accurately combined with the field border information 203. A field indexing module 205 uses the multispectral images and calculates vegetation indices for the area inside the field borders. In some embodiments the calculation of vegetation index may already have been performed external to the system of the invention. In such embodiments it is sufficient for the field vegetation indexing module 205 to extract the vegetation indices relating only to the area inside the field boundaries and disregard other areas. The process performed by the field indexing process substantially corresponds with step 102 of FIG. 1.

FIG. 4 shows an example of an index map 401 for the area delineated in FIG. 3. This example uses NDVI, but other indices may also be used. Various parts of the field are given different colors (shown in greyscale here), and a scale next to the map shows how the different colors represent different vegetation index values. The map shows, for example, that one area 402 has a low vegetation index. It will be noted that the scale is relative and only indicates relative differences in vegetation biomass. It is not possible to derive actual biomass from these indices. Consequently, it can be seen from the map that the vegetation index for area 402 is between 0.24 and 0.60, but what this represents in terms of actual yield is unknown. An in a different field, or with a different crop, the same vegetation index might represent a different yield.

The image and vegetation index scale shown in FIG. 4 is an example of what the output from the vegetation index module 205 may look like. This information is forwarded to an absolute yield estimation module 207. This module also obtains ground truthing information. In FIG. 2 this information is provided by a combine harvester 208 with a calibrated yield monitor. A yield monitor is a device which is well known in the art, and which measures the flow of harvested grain. Yield monitors may also be able to register grain moisture such that varying degrees of moisture in different parts of a field can be corrected for.

When an entire harvested amount is offloaded from the harvester 208 it can be weighed, and the yield monitor can be calibrated. After calibration the combine harvester 208 with its calibrated yield monitor may now be used to harvest selected areas of a field 301, preferably including areas that according to the vegetation index map 401 are at respective ends of the scale. The measured flow of grain and the position of the combine harvester 208, as registered by a positioning capability (e.g., a GPS receiver) of the yield monitor, may now be continuously registered while the harvester 208 is in operation, and the registered flow will represent yield at a corresponding position. This information may be used to create a yield map which is similar to the index map 401 to show the grain yield in the harvested portions of the field. FIG. 5 shows a yield map of the area shown in the two previous figures where a part 501 of the field has been harvested. It can be seen that the patterns of varying vegetation index that were revealed in the index map in FIG. 4 is confirmed in this yield map. For example, area 402 from the vegetation index map of FIG. 4 can be identified as area 502 in FIG. 5. Based on data from the yield monitor on the combine harvester that harvested the part 501 of the field it is known that the yield for area 502 is between 20.04 and 37.02 bushels per acre. This means that the indices obtained from earth observation satellite images 201 correlate with the absolute yield measurements obtained from a calibrated yield monitor.

Using the measured yield for a number of positions or subareas in the field and the calculated indices for the same positions or subareas as obtained from satellite or aerial images it is possible to correlate the two datasets and find the correspondence between yield and vegetation index, for example by using linear regression.

The following table is an example of correspondence between measured average yield and average NDVI for results that have been grouped in seven different zones or classes of yield.

| Zone/Class | Average Yield | Average NDVI |
|---|---|---|
| 1 | 28.53 | 0.42 |
| 2 | 40.72 | 0.65 |
| 3 | 46.75 | 0.71 |
| 4 | 50.75 | 0.75 |
| 5 | 53.87 | 0.77 |
| 6 | 60.94 | 0.79 |
| 7 | 81.19 | 0.84 |

This correspondence between ground truthing information and remote sensing data is used to create a regression equation for the relationship between vegetation index and yield. From the resulting formula, a virtual, or estimated absolute yield can be calculated from vegetation index values in each part of the field. The results may, for example, be given as tons per hectare, or bushels per acre.

In this particular example the equation will be:

Yield=104.2364*NDVI−21.371

Of course, the invention is not limited to linear regression and other approximations, for example polynomial or exponential regression may be used if they provide a function that better matches the available data.

Based on the equation representing a conversion from the dimensionless index values derived from multispectral images to an estimate of absolute yield in terms of for example bushels per acre or ton per hectare, it is possible to generate a number of useful output results. For this purpose, a system consistent with the principles of the invention may include an output module 209 which may be configured to take as input the yield equation found by the yield estimation module 207, vegetation index values for the field, and possibly also additional data layers such as maps or images. This information can be combined to generate output representing the estimated absolute yield for the field.

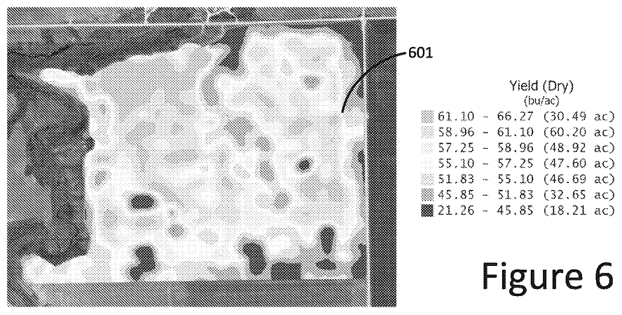

FIG. 6 is an example of such a virtual yield map 601 where the colors (represented as greyscale in the drawing) represent absolute yield. A scale shown next to the virtual yield map 601 shows the intervals of yield represented by different colors, and in this example also the estimated total acreage of the field with a yield in each interval (shown in parenthesis). In the example 30.49 acres are estimated to produce a yield of between 58.14 and 62.99 bushels per acre. 60.20 acres are estimated to yield between 56.13 and 58.14 bu/ac, and so on.

It is also possible to generate an estimate of the total yield for the entire field by summing up the estimated yield for each subsection of the field. This can be compared with the actual total yield after harvesting has been completed, and the yield map can be correspondingly adjusted.

FIG. 5 shows a field where only a part of the crop has been harvested. As described above, comparing this information with the vegetation indices for the corresponding part of the field as represented in the index map in FIG. 4, a relationship between vegetation index and absolute yield can be found. This relationship can be used to determine an estimate of the absolute yield for a larger part of the field, or the entire field. It has been found that the correlation between vegetation indices and yield is almost always strong, so that it is not necessary to collect actual yield data, also referred to as ground truthing information, from a substantial part of the field, which is why it is sufficient to use data from one calibrated yield monitor thus eliminating errors induced by obtaining yield estimates from several yield monitors that are inaccurately calibrated. It is, however, advantageous to collect such calibration data from the areas with the lowest and the highest yield potential, i.e., extreme yield zones of the field. Representative samples across the range from lowest to highest yield potential will facilitate regression analysis and it will not be necessary to extrapolate beyond the scope of the regression model. Therefore, collection of ground truthing information by harvesting portions of the field should be planned such that areas with high and low vegetation index are included in the sample. Furthermore, the ground truthing information may include outliers resulting, for example, from occasions where the combine harvester for some reason has not harvested grain across its full swath, due to yield monitor errors, or for other reasons. The effect of outliers may be reduced by increasing the size of the area harvested when collecting ground truthing data.

It should also be noted that it is possible to update the estimates whenever additional yield samples or new satellite or aerial images become available. This means that the yield estimates may be improved whenever additional data is received. Furthermore, with historical data available, it is possible to establish yield estimates based on vegetation indices derived from multispectral images obtained earlier in the growing season correlated with final absolute yield. Such estimates may be used to establish yield estimates earlier in the growing season.

This gives a number of use cases for the present invention. The invention is primarily a tool for generating a yield map for an entire field. In this context yield map means a representation of actual yield in various parts of the field, such as the example shown in FIG. 6. Subsequent to harvesting it is, of course, known what the actual total yield for a field has been. It is, however of considerable interest to identify parts of the field for which the yield deviates from the average. Obtaining this information from yield monitors mounted on several combine harvesters requires consistently calibrated monitors and is susceptible to a number of errors such as dependence on consistently harvesting from the full swath of the combine, consistent speed, and more. The invention thus provides an accurate and scalable way of obtaining information related to how yield has varied across different parts of a field.

Vegetation indices obtained earlier in the growing season may have weaker correlation with the actual yield data than the vegetation indices at the peak of the growing season, or right after the peak, but they can serve as an early estimate, or prediction, of actual yield. It is not possible to start harvesting subareas of the field early in the season in order to obtain ground truthing information, but by combining historical data with current vegetation indices it is possible to obtain an estimate. This can be done by correlating historical early season vegetation index maps with corresponding actual yield for the same year to derive a regression equation as described above and use the historical regression equation and the current vegetation index map to estimate yield for the current growing season. This estimate can be updated several times during the growing season and will get closer and closer to the actual yield, which will be found when current yield samples have been obtained.

The results provided by the invention have utility for farmers by helping to accurately identify areas of a field that are problematic or particularly successful in terms of yield. This information can be used as a basis for further investigation and analysis, for example by inspecting areas, analyzing the soil for nutrient content, ability to hold moisture, and more, and also by evaluating how different areas have benefited from precipitation and irrigation.

The results can be used to determine the amount and consistency of the fertilizer that should be applied after the growing season in order to appropriately replace, and potentially improve, the nutrients present in the soil for the next growing season. The results may also have impact on planned irrigation, use of pesticides, and other forms of agricultural field maintenance.

Some of the results provided by the invention may be available through other means. However, the invention also provides a more efficient way of obtaining these results than the methods currently being used. For example, field delineation is obtained from accurate, current, and scalable sources and does not rely on historical data that may be outdated, or on measurements made in the field itself. Ground truthing information is obtained without having to send agronomists or other experts into the field to perform manual work, and neither is it necessary to have consistently calibrated yield monitors in all combine harvesters used to harvest the field.

A system implementing an embodiment of the invention may comprise one or more computers with modules that are able to obtain the input information described above, process the information, and generate the required output. The system may include or be in communication with satellite systems, aerial photography providing devices such as drones or airplanes, yield monitors, and repositories of current or historical information provided by such sources of information. The information may be provided in the form of maps, tables and other representations, and may also be used as input to other systems that are used in the planning of agricultural field maintenance.

The instructions enabling a computer system to perform the steps provided by the invention may be carried by a computer readable medium.

1. A method in a computer system for estimating crop yield for an agricultural field from vegetation index data, comprising:
obtaining at least one multispectral image (201) of an area in which the field is located;
delineating the part of the multispectral image (201) that represents the agricultural field (301);
deriving vegetation indices for locations within the agricultural field (301) from the delineated part of the multispectral image (201);
obtaining samples of actual yield data representing yield measurements for locations within the agricultural field (301) as measured by a yield monitor on a combine harvester (208) used to harvest selected areas of the agricultural field (301); and
correlating the vegetation indices with the yield data to determine a relationship between respective vegetation index values and corresponding absolute yield estimates.

2. A method according to claim 1, wherein the delineation of the part of the multispectral image (201) is performed by automatically obtaining field delineation data from a repository of such information (204).

3. A method according to claim 1, wherein the delineation of the part of the multispectral image (201) is performed by:
obtaining at least one multitemporal, multispectral satellite image sequence from an earth observation satellite system (200);
improving the resolution of the multitemporal, multispectral satellite image sequence with a super-resolution method to generate a high-resolution image sequence where corresponding pixel positions in images in the sequence relate to the same geographical ground position; and
using a delineating artificial neural network to classify pixel positions in the high-resolution image sequence as being associated with a geographical ground position that is or is not part of the agricultural field.

4. A method according to claim 1, wherein the multispectral image (201) of the area in which the field is located is obtained using at least one of an earth observation satellite system (200), an airplane, and a drone (206).

5. A method according to claim 1, wherein the samples of actual yield data are obtained by selecting areas that according to the multispectral image (201) represent a range of vegetation index values including extremes, harvesting the selected areas with the combine harvester (208), and using grain flow rate data and corresponding position information from the yield monitor to determine the yield measurements for locations within the agricultural field (301).

6. A method according to claim 1, wherein regression analysis is used to determine the relationship between vegetation index and absolute yield as an equation that takes vegetation index as input and produces an absolute yield estimate as output.

7. A method according to claim 1, wherein the multispectral image of the field is obtained at or near the peak of the growing season.

8. A method according to claim 1, wherein at least one first multispectral image of the area in which the field is located was obtained early in a previous growing season, the samples of actual yield data were obtained during harvesting in the same previous growing season, regression analysis was used to determine a prediction equation that converts early season vegetation index to predicted absolute yield estimate, at least one second multispectral image of the area in which the field is located is obtained early in the current growing season, and the determined prediction equation is used to determine a predicted absolute yield for the current growing season from the at least one second multispectral image of the area in which the field is located.

9. A method according to claim 1, wherein the absolute yield estimate is delivered as input to a process of determining at least one of a future fertilization rate, a future irrigation rate, and a future use of pesticides.

10. A system for estimating crop yield for an agricultural field from vegetation index data, comprising:
a field delineation module (202) configured to receive at least one multispectral image (201) of an area in which the field is located and delineate the part of the multispectral image (201) that represents the agricultural field (301);
a field indexing module (205) configured to receive the delineated part of the at least one multispectral image (201) and derive vegetation indices for locations within the agricultural field (301);
a yield estimation module (207) configured to receive samples of actual yield data representing yield measurements for locations within the agricultural field (301) as measured by a yield monitor on a combine harvester (208) used to harvest selected areas of the agricultural field (301), and to correlate the vegetation indices with the yield data to determine a relationship between respective vegetation index values and corresponding absolute yield estimates.

11. A system according to claim 10, wherein the field delineation module (202) is further configured to:
obtain at least one multitemporal, multispectral satellite image sequence from an earth observation satellite system (200);
improve the resolution of the multitemporal, multispectral satellite image sequence with a super-resolution method to generate a high-resolution image sequence where corresponding pixel positions in images in the sequence relate to the same geographical ground position; and
use a delineating artificial neural network to classify pixel positions in the high-resolution image sequence as being associated with a geographical ground position that is or is not part of the agricultural field.

12. A system according to claim 10, further comprising a multispectral camera module configured to be carried by an airplane or a drone (206) and to communicate with the field indexing module (205).

13. A system according to claim 10, further comprising a yield monitor module with a positioning capability and configured to be mounted on a combine harvester (208) and to communicate with the yield estimation module (207).

14. A system according to claim 10, further comprising an output module (209) configured to receive as input the determined relationship found by the yield estimation module (207) together with vegetation index values for the field and to produce as output at least one of: a table of absolute yield estimates, an estimated total yield for the field, and a yield map.

15. A computer program product on a computer readable medium comprising instructions enabling a computer system to perform the steps of claim 1.
